(19) United States
(12) Patent Application Publication
(10) Pub. No.: US 2018/0280801 A1
(43) Pub. Date: Oct. 4, 2018

(54) System and Method for Placement Marketing

(71) Applicants: Chien-Jiun Wang, Taoyuan City (TW); Yao-Sin Tsai, Hualien County (TW)

(72) Inventors: Chien-Jiun Wang, Taoyuan City (TW); Yao-Sin Tsai, Hualien County (TW)

(21) Appl. No.: 15/940,540

(22) Filed: Mar. 29, 2018

(30) Foreign Application Priority Data
Mar. 30, 2017 (TW) 106110831

(51) Int. Cl. A63F 13/61; G06Q 30/02

(52) U.S. Cl. CPC A63F 13/61; A63F 2300/5506; G06Q 30/0277; G06Q 30/0201

(57) ABSTRACT

A system for placement marketing includes a remote server, at least one message provider and at least one portable device. The remote server includes a memory, a data analyzer module, a data classifying module, a combination type generator and a first combination type game module. The at least one portable device transmits wirelessly a user information to the remote server. The at least one message provider transmits its message to the remote server. The portable device includes a second combination type game module for facilitating process and result of the combination type game displaying on a display of the portable device, and therefore the delivered message of the at least one message provider is shown.

### FIELD OF THE INVENTION

The present invention relates to an internet marketing, and particularly to a system and method for placement marketing.

### BACKGROUND OF THE INVENTION

The rapid development of Internet technology has created many new business models, in which Internet marketing is an obvious example. From the statistics of turnover of many products, it can be found that the proportion of turnover generated by internet marketing is increasing steadily. With the advantages of free of the physical store and reduction cost of human resource in Internet marketing, it is challenging the marketing way of the traditional physical store. In addition to the advantages of selling cost, life style is very much tied to Internet. In the mode of commodity advertising, the Internet marketing has been gradually valued by proprietors compared with the traditional TV or print media marketing. For example, in the current and future of the Internet community, the Word-of-Mouth recommendation of Internauts or friends will be much more effective than the advertisement that the proprietor has launched. However, although the Internet marketing can be applied by quite diverse marketing channel, such as Internet advertising, blog marketing, forum marketing, community marketing, content placement marketing and so on, how to attract users, efficiently has become a major problem in the use of Internet marketing.

In addition, with the raising of electronic digital game, electronic devices need to get the resource data at any time from Internet server providing for different stages of operation in the game proceeding. For example, when the user terminal enters the on-line game, the computer requests the Internet server to provide background picture of the game interface, or when the user terminal performs game upgrading task, the computer needs to request the Internet server providing configuration file which involves the game upgrading rule. In addition, the electronic equipment also requires the user data will be synchronized to the network side server generated in the course of the game. For example, computer users will upload to the Internet server side game points to the network side server for all users of social networking sites in game rankings; or, the user experience and content data uploaded to the Internet. The server side, so that users in the mobile phone game, mobile phone users can request these data to the network side server, allowing the user to continue the game on mobile phone.

Current well-known probability type games include point number game such as dice game, card draw game, matching pairs game or roulette game, etc. The player only needs to wager and operate simply and even only needs to wager to complete the game because the operation of the probability type game is very simple. The outcome of the game depends on the probability, and the player needn't spend a lot of time to focus his/her attention on the game and think about it. Thus, the probability type game is often very popular in the playground and sometimes is also employed as a subsidiary game of other games. For instance, the probability type game is utilized in the online game or the table game as a mechanism to decide whether an item can be obtained and an event can be triggered or not, or what kind of item can be acquired and what kind of event can be triggered.

In view of the dullness of the traditional game un-capable of attracting players continuously and the traditional Internet marketing, the present invention provides a novel system and method of placement marketing to enhance the attraction of the game and achieve the purpose of marketing.

### SUMMARY OF THE INVENTION

One object of the present invention is to provide a method of placement marketing, comprising: inputting information provided by at least one information provider to a remote server; generating a combination type game by a combination type game generator based-on a user's selection or an information classification module to classify the information; and transmitting the combination type game to a user terminal device for playing the combination type game to generate outcome of desired communicating information of the at least one information provider.

According to one aspect of the present invention, the method further comprises storing the information provided by the information provider in a memory of the remote server.

In one aspect, the method further comprises inputting user raw data of at least one user terminal device to the remote server; inputting the user raw data and the information to a data mining module of the remote server to generate selected users and selected information; and outputting the selected information and the selected users to the information classification module.

In another aspect, the selected information/users are outputted to the information classification module from the data mining module. The selected information/users are outputted to the information classification module from a memory of the remote server. The combination type game module is embedded in the user terminal device and/or the remote server.

In still another aspect, the method further comprises storing the user raw data in a memory of the remote server. The method further comprises classifying the selected information by the information classification module to generate the multiple sets of information; and matching the selected user with the multiple sets of information in the combination type game generator to generate a specific (matched) information as a subject of the combination type game.

In yet another aspect, a method of placement marketing comprises inputting information provided by at least one information provider to a remote server; generating a comparison type game by a comparison type game generator based-on a user's selection or an information classification module to classify the information; and transmitting the comparison type game to a user terminal device for playing the comparison type game to generate outcome of desired communicating information of the at least one information provider.

The method further comprises classifying the selected information by the information classification module to generate the multiple sets of information; and matching the selected user with said multiple sets of information in the comparison type game generator to generate multiple information as a subject of the comparison type game.

These and other advantages will become apparent from the following description of preferred embodiments and the appended claims.

### BRIEF DESCRIPTION OF THE DRAWINGS

The present invention may be understood by some preferred embodiments and detailed descriptions in the specification and the attached drawings below. However, it should be appreciated that these drawings are only utilized for illustrating the present invention, not for limiting the present invention to one specific embodiment.

FIG. 1 is a functional block diagram of a system of placement marketing in accordance with the present invention.

FIG. 2 is a functional block diagram of a system of placement marketing in accordance with one embodiment of the present invention.

FIG. 3 is a functional block diagram of a portable device in accordance with the present invention.

FIG. 4 is a diagram of a game generator in accordance with one embodiment of the present invention.

FIG. 5 is a diagram showing a game module in accordance with one embodiment of the present invention.

FIG. 6 is a functional block diagram of a system of placement marketing in accordance with another embodiment of the present invention.

### DETAILED DESCRIPTION OF THE PREFERRED EMBODIMENT

The present invention will now be described in detail with the specific embodiments and aspects and these descriptions interpret structure and procedures of the present invention only for illustrating but not for limiting the Claims of the present invention. Therefore, except the specific and preferred embodiments in the specification, the present invention may also be widely performed in other embodiments.

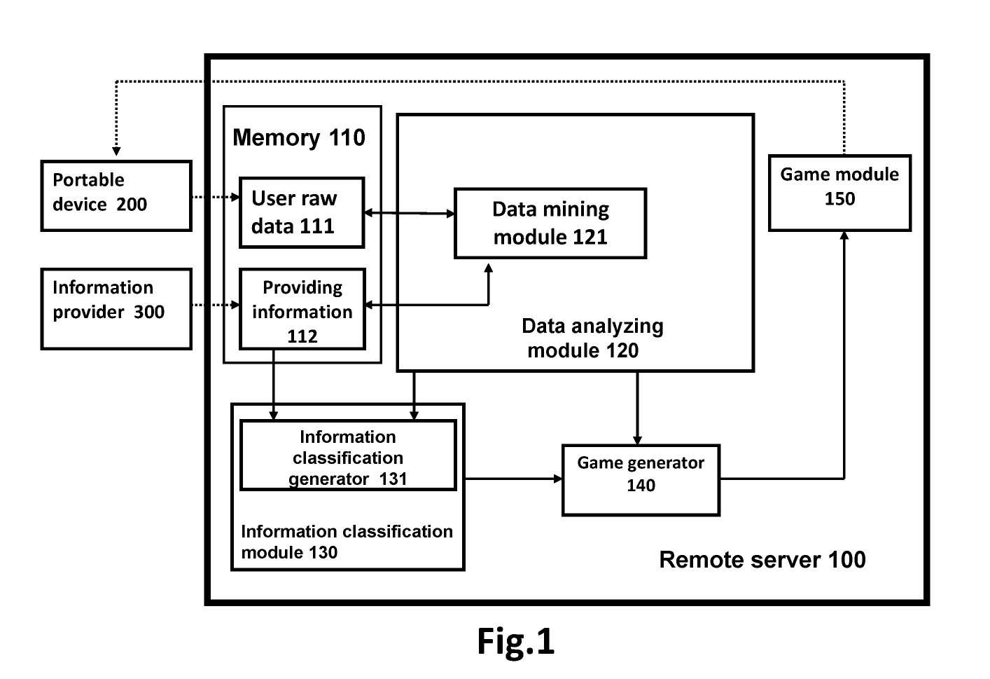

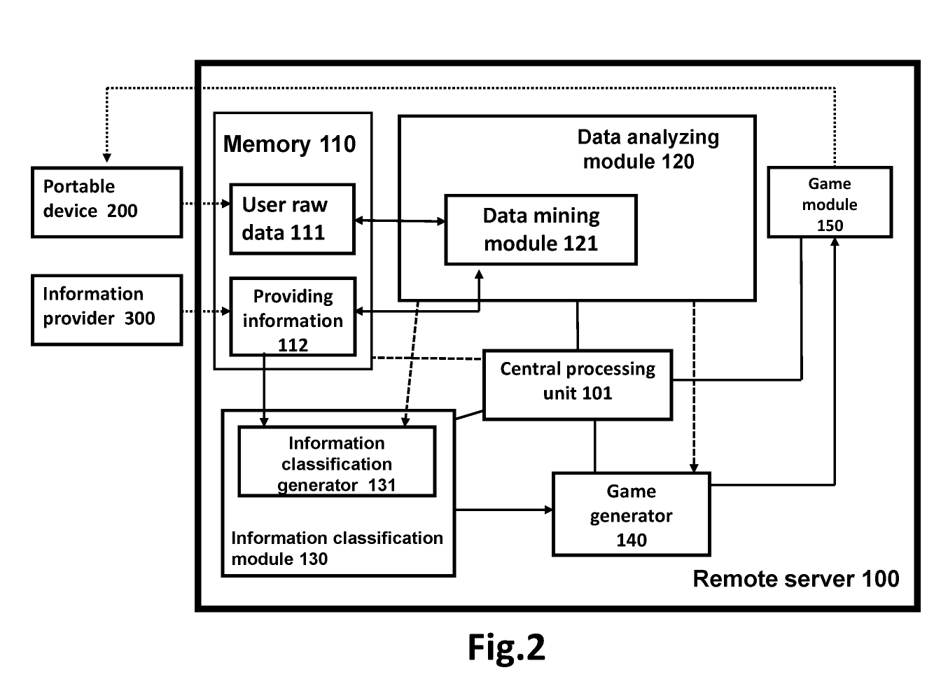

Please refer to FIG. 1, which illustrates a functional block diagram of a system of placement marketing of the present invention. The system includes at least one remote server 100, at least one portable device 200 and at least one information provider 300. The remote server 100 may include a memory 110, a data analyzing module 120, an information classification module 130, a game generator 140 and a game module 150. In one embodiment, the memory 110 is coupled to the data analyzing module 120 and the information classification module 130. In one embodiment, the game generator 140 is also coupled to the data analyzing module 120 and the information classification module 130. The game generator 140 is coupled to the game module 150. The game module 150 is coupled to the portable device 200 to transmit the information data of the executed game to the portable device 200, so as to display the course and the outcome of the game via the display unit in the portable device 200. The data analyzing module 120 may include a data mining module 121 to extract useful patterns and relationships or knowledge from bulk data. The matching result between the user information and the advertisement contents may be generated by the data mining module 121. Generally, the remote server 100 may include a central processing unit 101, wherein the memory 110, the data analyzing module 120, the information classification module 130, the game generator 140 and the game module 150 are electrically coupled to the central processing unit 101, shown as in FIG. 2.

Usually, in the system of the present invention, a plurality of portable devices 200 and a plurality of information providers 300 provide associated data of the individual user and individual information (such as advertisement information) to the remote server 100, respectively. For example, the remote server 100 may receive or load user raw data 111 and providing information 112 respectively transmitted from the portable devices 200 and the information providers 300. In one embodiment, the user raw data 111 and the providing data 112 may be stored in the memory 110 of the remote server 100. In one embodiment, the plurality of portable devices 200 may transmit the associated data of the user to the remote server 100 through wireless transmission or wireless communication method, as shown in FIG. 1. For instance, the user raw data 111 may include gender, age, education level, consumption habit, consumer behavior, preference, interest, etc of the user, while the providing information 112 may include the mark of a specific company, advertisement icon images, advertisement content images, promotions information, information transmitted from public agencies or private agencies (such as publicity, propaganda or advertisement) which may indicate product advertisement, institutional advertisement or brand advertisement, etc.

In one embodiment, the data mining module 121 may include but be not limited to the following five functions or sub-modules: classification functions or sub-modules, estimation functions or sub-modules, prediction functions or sub-modules, affinity grouping functions or sub-modules and homogeneous clustering functions or sub-modules. For example, the classification functions/sub-modules may perform classification and perform definition according to the attributes of the analyzed subject to establish classes. For instance, the attributes of the mobile phone user may be classified as high-level economic capability user, medium-level economic capability user and low-level economic capability user. The used technique may include decision tree, memory-based reasoning, etc. The estimation functions or sub-modules obtain an unknown value of the attribute of a certain user according to the associated attribute data of the existing continuous values. For example, appropriate advertisement types or advertisement amounts for the mobile phone user are estimated according to his/her education level and consumer behavior of the mobile phone user. The used technique may include the associated analysis of the statistical method, regression analysis and artificial neural network method, etc. The prediction functions or sub-modules predict the future values of the attribute according to the past observed values of the user's attribute. For instance, the future consumption preferences, consumption types and consumption amount of the mobile phone user are predicted based on his/her past consumption preferences, consumption types and consumption amount. The used technique may include regression analysis, time series analysis and artificial neural network method, etc. The affinity grouping functions or sub-modules determine which associated advertisements in all advertisement symbols should be positioned together. For example, the symbols of the associated, analogies information (such as advertisements) provided by a plurality of the information providers 300 to the remote server 100 are positioned in the same group to be chosen. In the system of the present invention, this function is employed to provide the information in the same group to the information classification module 130 so as to generate the same set of information. All information databases provided by the information provider 300 are classified into more homogeneous clusters by the homogeneous clustering functions or sub-modules. Homogeneous clustering is equivalent to segmentation in the marketing terminology. It is assumed that the segmentation is not defined in advance and the segmentation is generated automatically from information. The used technique may include k-means method and agglomeration method, etc.

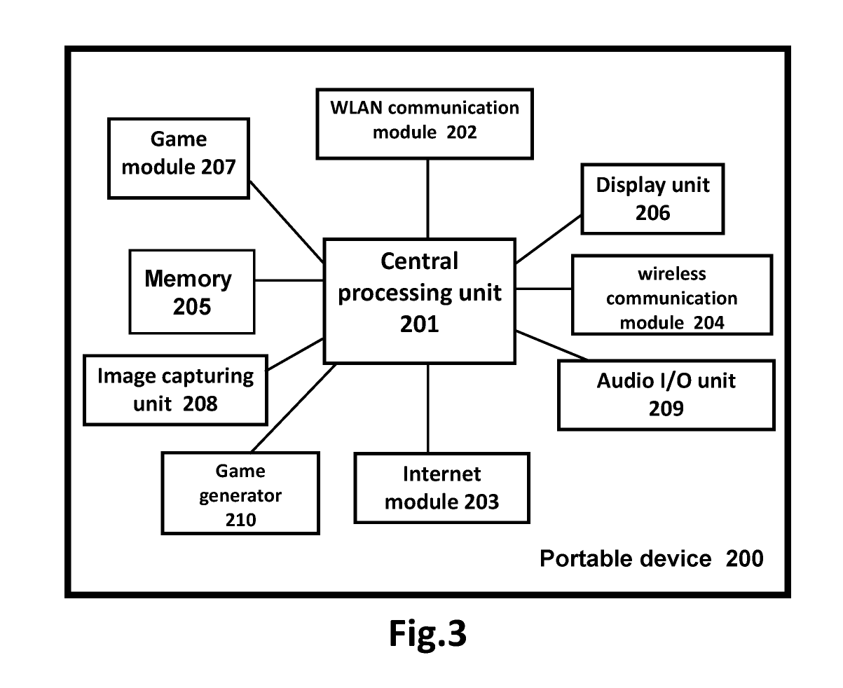

Please refer to FIG. 3, it illustrates a functional block diagram of the user terminal or portable device of the present invention. FIG. 3 only shows or indicates essential elements, and other elements which are not the technical features of the present invention are omitted. In this embodiment, the portable device 200 can transmit the user-related raw data to the remote server 100 through the wireless communication method and/or Internet network. Namely, a wireless communication module 204, a wireless local area network (WLAN) communication module 202 and/or an internet module 203 may be employed to transmit the data. The portable device 200 may transmit or receive wireless audio or image signals via the internet module 203. The portable device 200 may include a SIM connector (not shown) to receive a SIM (subscriber identity module) card. The portable device 200 may include the wireless communication module 204 coupled to the central processing unit 201. For instance, the wireless communication module 204 may include a RF communication module, which may include an antenna coupled to transceiver. The transceiver may be utilized to receive or transmit signals. The RF communication module may also include a MODEM (modulator-demodulator), a base band processing device, a down converter, a digital signal processor, etc, which are well known to the person having ordinary skill in the art. The RF communication module can process and be compatible to communication protocols of the mobile phone, which may include but be not limited to GSM (Global System for Mobile Communications), CDMA (Code Division Multiple Access), PHS (Personal Handy-phone System), etc. The received signals are processed by the RF communication module, are then transmitted to a CODEC (encoder and decoder) for decoding, and subsequently inputted to the digital-analog converter for converting into analog signals, which is outputted by an audio I/O (input/output) unit 209. On the contrary, the analog audio signals are inputted via the audio I/O unit 209 and converted into digital signals by the digital-analog converter, which is encoded by the CODEC and followed by emitting after processing by the RF communication module. Furthermore, the wireless local area network communication module 202 is coupled to the central processing unit 201 and the CODEC.

As shown in FIG. 3, the portable device 200 of the present invention may include the central processing unit/control IC 201 to perform signal control, processing of data, power control and processing of input and output signals. A game module 207, a game generator 210, an operating unit (not shown), a built-in display unit 206, an operating system (not shown) and an image capturing unit 208 are electrically coupled to the control IC 201, respectively.

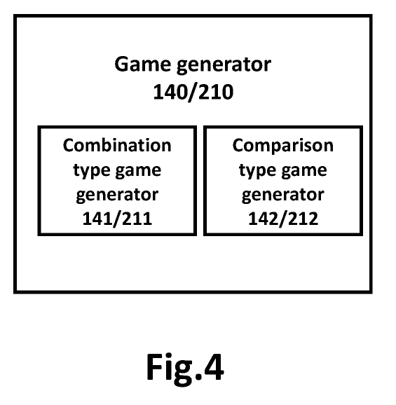

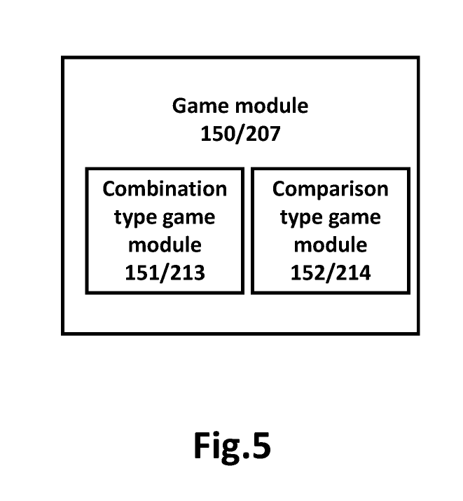

Games resource of the game module 207 is obtained by (1) the game generator 140 of the remote server 100 transmitting to the game module 207 of the portable device 200 through wireless module; (2) the game generator 210 of the portable device 200, stored into or sent to the game module 207. In an embodiment, the portable device 200 can generate games by its game generator 210 and formulate game rules. In one embodiment, the game generator 210 includes but not limited to a combination type game generator 211 and a comparison type game generator 212, which can produce a combination type game and a comparison type game respectively, as shown in FIG. 4. In one embodiment, the game module 207 includes but not limited to a combination type game module 213 and a comparison type game module 214. In one embodiment, the generated combination type game and comparison type game can be transmitted to the combination type game module 213 and the comparison type game module 214 of the game module 207 respectively, and stored in thereof, as shown in the FIG. 5. Therefore, the combination type game module 213 includes combination type games generated by the combination type game generator 211 based on information provided by the information provider 300, and the comparison type game module 214 includes comparison type games generated by the comparison game generator 212 based on information provided by the information provider 300. Users can select a specific combination type game for playing via the combination type game module 213 of portable device 200, or select a specific comparison type game for playing via the comparison type game module 214. For example, the combination type games of the invention include but not limited to puzzle game, Tetris game (traditional building game) or 3D (three-dimensional) building game. The comparison type games of the invention include but not limited to matching pairs game. It should be noted that subject of the game includes information or delivering message transmitted by the information provider 300. For example, the rule of flop game (matching pairs game) is finding two identical information transmitted by the information provider 300, and the two identical information can be eliminated in the picture on the display screen. The above picture contains several information, which is arranged in some way to facilitate the selection. For example, an information provided by the information provider 300 is used as the subject of the jigsaw puzzle game. This information can be divided into N sub-pictures or sub-blocks in a picture or block, adjacent sub-blocks can swap (exchange each other) for puzzle game, N is an integer. Based-on the number of N (or number of swap/exchange steps to complete the original information), this game can be designed as pass challenges with different levels.

As shown in FIG. 3, the portable device 200 may also include a memory 205 coupled to the control IC 201 to store data and the operating system. Depending upon different attributes, the memory 205 may include ROM (read-only memory), RAM (random access memory), nonvolatile flash memory, etc. The RF communication module may process the received signals, baseband signals, digital signals, etc. The audio signals are transmitted to the output device such as speaker/microphone unit. In general, unchanged data may be stored in Mask ROM while the system operating software or the application program may be generally stored in the nonvolatile memory. A wired input/output (I/O) interface is coupled to the control IC 201, which may be USB (Universal Serial Bus), Fire wire or IEEE 1394 interface.

The wireless local area network (WLAN) communication module 202 is compatible to and may process the transmission data of the wireless local area network protocols. For example, the wireless local area network (WLAN) communication module 202 may be Bluetooth compatible module, Wi-Fi wireless transmission standard compatible module, 802.11x wireless transmission standard compatible module, WiMAX (Worldwide Interoperability for Microwave Access) wireless transmission standard compatible module. The portable device of the present invention can transmit or receive audio signals or image signals wirelessly and simultaneously by the WLAN communication module 202.

As mentioned above, the user can utilize the portable device 200 to transmit/input the user raw data to the remote server 100 via the wireless communication module 204, the WLAN communication module 202 and/or the internet module 203. In this embodiment, the user raw data 111 may include personal data, the user's preference or favor and any data which the user agrees to input. The user raw data 111 are for example stored in the memory 110 of the remote server 100.

The present invention is to provide a method of placement marketing, comprising: inputting information provided by at least one information provider to a remote server; generating a combination type game by a combination type game generator based-on a user's selection or an information classification module to classify the information; and transmitting the combination type game to a user terminal device for playing the combination type game to generate outcome of desired communicating information of the at least one information provider.

In yet another aspect, a method of placement marketing comprises inputting information provided by at least one information provider to a remote server; generating a comparison type game by a comparison type game generator based-on a user's selection or an information classification module to classify the information; and transmitting the comparison type game to a user terminal device for playing the comparison type game to generate outcome of desired communicating information of the at least one information provider. The process flow of the method of the above two placement marketing describe as the following.

The information provider 300 transmits/inputs the providing information 112 to the remote server 100. Similarly, the information provider 300 can also transmit/input the providing information to the remote server 100 by utilizing the built-in wireless communication module, the WLAN communication module and/or the internet module. The information provider 300 may for instance be a data transmitting terminal (such as a server) provided by the advertiser, advertiser entrusted by an enterprise or a third party. The providing information 112 are for example be stored in the memory 110 of the remote server 100. The providing information 112 may include but be not limited to text, image, picture, video or the combination thereof.

The user raw data 111 and the providing information 112 are inputted to the remote server 100 and stored in the memory 110. Subsequently, the user raw data 111 and the providing information 112 are inputted to the data analyzing module 120. The user raw data 111 and the providing information 112 are performing a series of computing processes of analyzing, comparing, classifying, predicting and estimating by employing the data mining module 121 of the data analyzing module 120 to generate appropriate or qualified users and information (such as advertisement symbols) provided by the information provider. Then, the data mining module 121 outputs the chosen user and information (advertisement symbol) respectively into the game generator 140 and the information classification module 130. The data mining module 121 still needs to request the modified or new user raw data 111 at any time because the user of the portable device 200 might update his/her basic data or personal information at different time or under different situations. Moreover, the data mining module 121 still needs to request the modified or new providing information 112 at any time because the information provider 300 may also modify the information (advertisement contents) at different time or under different situations. The aforementioned action of request may be executed by the data mining module 121 or by the central processing unit 101.

Subsequently, the data mining module 121 transmits a series of the chosen information to the information classification module 130. As the information classification module 130 receives the information, the chosen information (advertisement symbols) are then requested to input into the information classification module 130 from the memory 110. The aforementioned action of request may be executed by the information classification module 130 or by the central processing unit 101. Then, the information classification generator 131 performs a procedure of classifying the chosen information to generate multiple information sets, such as n information sets, wherein n is an integer. The multiple sets of information (advertisement symbols) are transmitted to the game generator 140. For example, each set of information (advertisement symbol) may include a plurality of different information (such as similar advertisement symbol or dissimilar advertisement symbol). In one embodiment, the information may include the combination of the advertisement picture and the common picture.

Subsequently, according to the selected users outputted by the data mining module 121 to the game generator 140 and the multiple sets of information outputted by the information classification module 130 to the game generator 140, the selected users are matched with the multiple sets of information in the game generator 140 to generate an information for a combination type game, or multiple information for a comparison type game. The constituting element (subject of game) of the combination type game are the matched information. The constituting elements (subject of game) of the comparison type game are the matched multiple information. In another embodiment, each user may assign/select an information for the subsequent combination type game, or multiple information for the subsequent comparison type game, via a game interface of the portable device. The game rules of the combination type game are defined in the combination type game generator 141 or the combination type game module 151. That is to say, the game rules of the combination type game are pre-defined in the slot game. For example, in the combination type game generator 141, an information is assigned to a portable device 200 of a user to facilitate to generate a combination type game. Then, the matched user of the portable device 200 and the matched information are outputted from the combination type game generator 141 to the combination type game module 151 for facilitating playing the combination type game. In other words, the combination type game may be created by game rules of the combination type game module 151 and the combination type generator 141, such that the combination type game may be performed or displayed in the portable device 200 by transmitting the combination type game to the portable device 200. In one embodiment, the combination type game may be performed in the combination type game module 151 of the remote server 100. In another embodiment, the combination type game may be performed in the combination type game module 213 of the portable device 200. Furthermore, the display unit 206 of the portable device 200 may display the process and the outcome of the combination type game in the combination type game module 150 because the combination type game module 151 of the server is coupled to the combination type game module 213 of the portable device 200. The constituting element (subject of game) of the combination type game is the information provided by advertiser or enterprise, etc., and therefore it can achieve the purpose of placement marketing.

In one embodiment, the game rules of the comparison type game are defined in the comparison type game generator 142 or the comparison type game module 152. The number of information the combination type game is also pre-defined in the comparison type game. For example, in the comparison type game generator 142, multiple information are assigned to a portable device 200 of a user to facilitate to generate a comparison type game. Then, the matched user of the portable device 200 and the matched information are outputted from the comparison type game generator 142 to the comparison type game module 152 for facilitating playing the comparison type game. In other words, the comparison type game may be created by game rules of the comparison type game module 152 and the comparison type generator 142, such that the comparison type game may be performed or displayed in the portable device 200 by transmitting the comparison type game to the portable device 200. In one embodiment, the comparison type game may be performed in the comparison type game module 152 of the remote server 100. In another embodiment, the comparison type game may be performed in the comparison type game module 214 of the portable device 200. Furthermore, the display unit 206 of the portable device 200 may display the process and the outcome of the comparison type game in the comparison type game module 152 because the comparison type game module 152 of the server is coupled to the comparison type game module 214 of the portable device 200. The constituting elements (subjects of game) of the comparison type game are the information provided by advertiser or enterprise, etc., and therefore it can achieve the purpose of placement marketing.

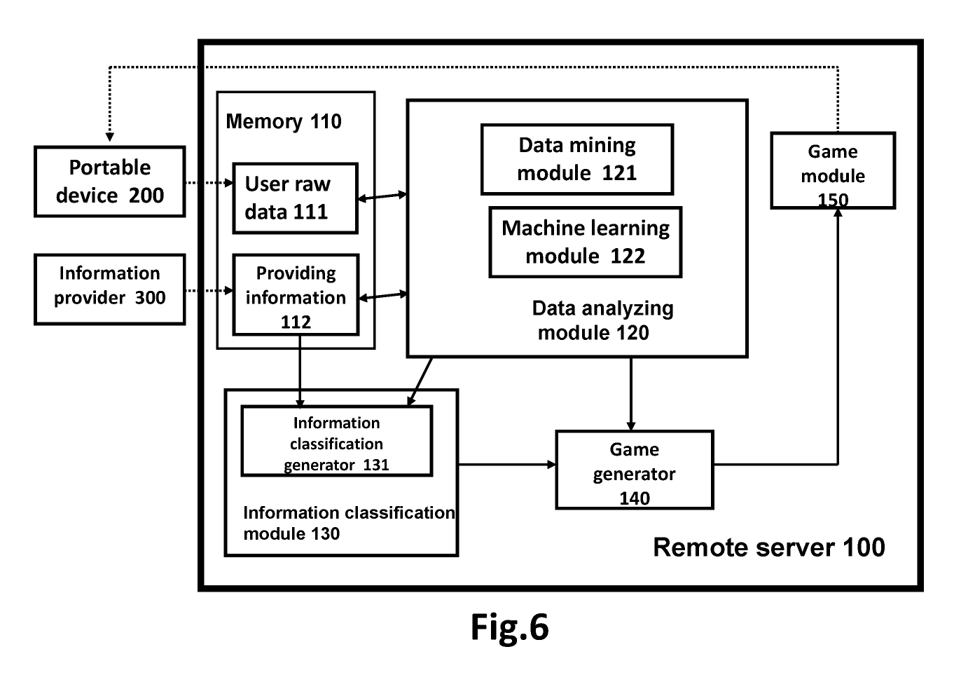

Please refer to FIG. 6, which illustrates a functional block diagram of the system of placement marketing in accordance with another embodiment of the present invention. In this embodiment, the data analyzing module 120 may include the data mining module 121 and a machine learning module 122. The machine learning module 122 mainly combines the pattern recognition with the computational learning method, so as to assist operation of the data mining module 121.

In the present invention, the information classification module 130 is used classify the advertisement subjects (symbols) to provide for the selected user. The game generator 140 can generate a combination type game or a comparison type game by inputting the selected users and advertisement symbols, and the combination type game or the comparison type game may be transmitted to the portable device or the client device 200 of the selected user. The portable device may for instance be smart phone, tablet PC, personal computer, computing device, wireless communication device, mobile phone, gaming machine, gaming apparatus, gaming console, virtual reality device, or other electronic devices, electronic apparatus, electronic machines. The term “wireless communication device” is used herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways. The portable device or the client device 200 feeds the data into the data analyzing module 120 and the game generator 140, such that the interactive procedures may be performed.

It should be appreciated that the embodiments described herein are described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof.

What is claimed is:

1. A method of placement marketing, comprising:
inputting information provided by at least one information provider to a remote server;
generating a combination type game by a combination type game generator based-on a user's selection or an information classification module to classify said information; and
transmitting said combination type game to a user terminal device for playing said combination type game to generate outcome of desired communicating information of said at least one information provider.

2. The method of claim 1, further comprising storing said information provided by said information provider in a memory of said remote server.

3. The method of claim 1, further comprising:
inputting user raw data of at least one user terminal device to said remote server;
inputting said user raw data and said information to a data mining module of said remote server to generate selected users and selected information; and
outputting said selected information and said selected users to said information classification module.

4. The method of claim 3, wherein said selected information is outputted to said information classification module from said data mining module.

5. The method of claim 3, wherein said selected information is outputted to said information classification module from a memory of said remote server.

6. The method of claim 3, further comprising storing said user raw data in a memory of said remote server.

7. The method of claim 3, further comprising:
classifying said selected information by said information classification module to generate said multiple sets of information; and
matching said selected user with said multiple sets of information in said combination type game generator to generate a matched information as a subject of said combination type game.

8. The method of claim 1, wherein said combination type game generator includes a puzzle game, a traditional building game or a 3D building game.

9. The method of claim 1, wherein said combination type game module is embedded in said user terminal device.

10. The method of claim 1, wherein said user terminal device includes smart phone, mobile phone, tablet PC, personal computer, wireless communication device, virtual reality device, gaming machine or gaming console.

11. A method of placement marketing, comprising:
inputting information provided by at least one information provider to a remote server;
generating a comparison type game by a comparison type game generator based-on a user's selection or an information classification module to classify said information; and
transmitting said comparison type game to a user terminal device for playing said comparison type game to generate outcome of desired communicating information of said at least one information provider.

12. The method of claim 11, further comprising storing said information provided by said information provider in a memory of said remote server.

13. The method of claim 11, further comprising:
inputting user raw data of at least one user terminal device to said remote server;
inputting said user raw data and said information to a data mining module of said remote server to generate selected users and selected information; and
outputting said selected information and said selected users to said information classification module.

14. The method of claim 13, wherein said selected information is outputted to said information classification module from said data mining module.

15. The method of claim 13, wherein said selected information is outputted to said information classification module from a memory of said remote server.

16. The method of claim 13, further comprising storing said user raw data in a memory of said remote server.

17. The method of claim 13, further comprising:
classifying said selected information by said information classification module to generate said multiple sets of information; and
matching said selected user with said multiple sets of information in said comparison type game generator to generate multiple information as a subject of said comparison type game.

18. The method of claim 11, wherein said comparison type game generator includes a matching pairs game.

19. The method of claim 11, wherein said comparison type game module is embedded in said user terminal device.

20. The method of claim 11, wherein said user terminal device includes smart phone, mobile phone, tablet PC, personal computer, wireless communication device, virtual reality device, gaming machine or gaming console.
